(19) United States
(12) Patent Application Publication
(10) Pub. No.: US 2005/0195106 A1
(43) Pub. Date: Sep. 8, 2005

(54) Hand held wireless occupant communicator

(76) Inventors: Alan C. Davis, Fenton, MI (US); Richard K. Riefe, Saginaw, MI (US); Frederick J. Berg, Auburn, MI (US); Ronald H. Dybalski, Oxford, MI (US); Richard P. Nash, Frankenmuth, MI (US)

Correspondence Address: DELPHI TECHNOLOGIES, INC., M/C 480-410-202, PO BOX 5052, TROY, MI, 48007, US

(21) Appl. No.: 10/792,419

(22) Filed: Mar. 3, 2004

(51) Int. Cl. G01S 5/14; B60R 25/10

(52) U.S. Cl. 342/357.08

(57) ABSTRACT

A communication system includes a remote device for communicating with a vehicle. Both the vehicle and the remote device have global positioning system (GPS) receivers for determining the location of the vehicle and remote device respectively. The remote device computes the direction, distance, and elevation difference between the remote device and the vehicle. The remote device also includes a digital compass for determining the direction the remote device is pointed. A display on the remote device shows an arrow, along with the distance and elevation difference, to guide a user to the vehicle. The remote device can also send control commands to vehicle systems and receive status data from vehicle systems.

### BACKGROUND OF THE INVENTION

1. Field of the Invention

The subject invention relates generally to a communication system for a vehicle and specifically to a remote device for communication with the vehicle.

2. Description of the Related Art

Various systems and devices for communicating with a vehicle are well known in the prior art. An example of such a system is disclosed in U.S. patent application Publication 2003/0139179 (the '179 publication).

The '179 publication discloses a system for communicating with a vehicle with a remote device. The remote device can utilize a wide area network, such as a cellular telephone network or TCP/IP, and a local area network, such as Bluetooth or 802.11. The remote device can include human interface elements, such as a display, one or more control buttons or knobs, a speaker, and a microphone. A user of the remote device can access, control, operate, and check the status of at least one vehicle system. The vehicle and the remote device each include a position system to determine the position of the vehicle and the remote device respectively. The remote device calculates the relative position of the vehicle to the remote device.

The known communication system above does not, however, provide a remote device operative to indicate direction, distance, and elevation difference to the vehicle from the remote device on an updating basis to guide a user to the vehicle. Moreover, the above remote device is not equipped with a digital compass or other directional display, to show an arrow on a display to indicate direction to the vehicle from the remote device.

### BRIEF SUMMARY OF THE INVENTION AND ADVANTAGES

The subject invention provides a remote device for communicating with a vehicle. The vehicle is equipped with a vehicle global positioning system (GPS) receiver for determining location coordinates of the vehicle and a vehicle wireless interface for transmitting the location coordinates of the vehicle. The remote device includes a remote device wireless interface for receiving the location coordinates of the vehicle. The remote device also includes a remote device GPS receiver for determining location coordinates of the remote device. A processor is operatively connected to the remote device wireless interface and the remote device GPS receiver to calculate the relative position of the remote device to the vehicle. The remote device is characterized by an output apparatus operatively connected to the processor for indicating direction, distance, and elevation difference to the vehicle from the remote device.

Accordingly, the remote device of the subject invention allows a user to find the vehicle quickly and easily.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 illustrates a user utilizing a remote device with a communication system to locate a vehicle;

FIG. 2 is a block diagram of a preferred embodiment of the communication system showing the remote device and the vehicle;

FIG. 3a is a front view of the preferred embodiment of the remote device;

FIG. 3b is a front view of a first alternative embodiment of the remote device; and

FIG. 3c is a front view of a second alternative embodiment of the remote device.

### DETAILED DESCRIPTION OF THE INVENTION

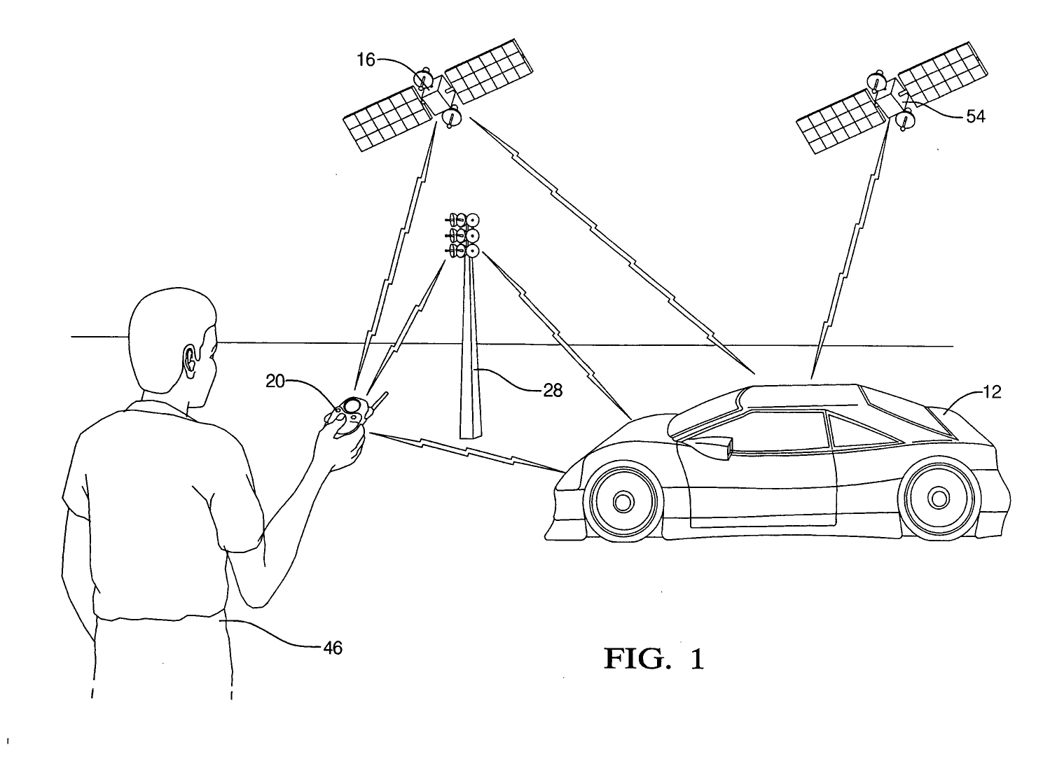

Referring to the Figures, wherein like numerals indicate like or corresponding parts throughout the several views, a communications system is shown at 10 in FIG. 1. The communications system 10 includes a vehicle 12 and a remote device 20.

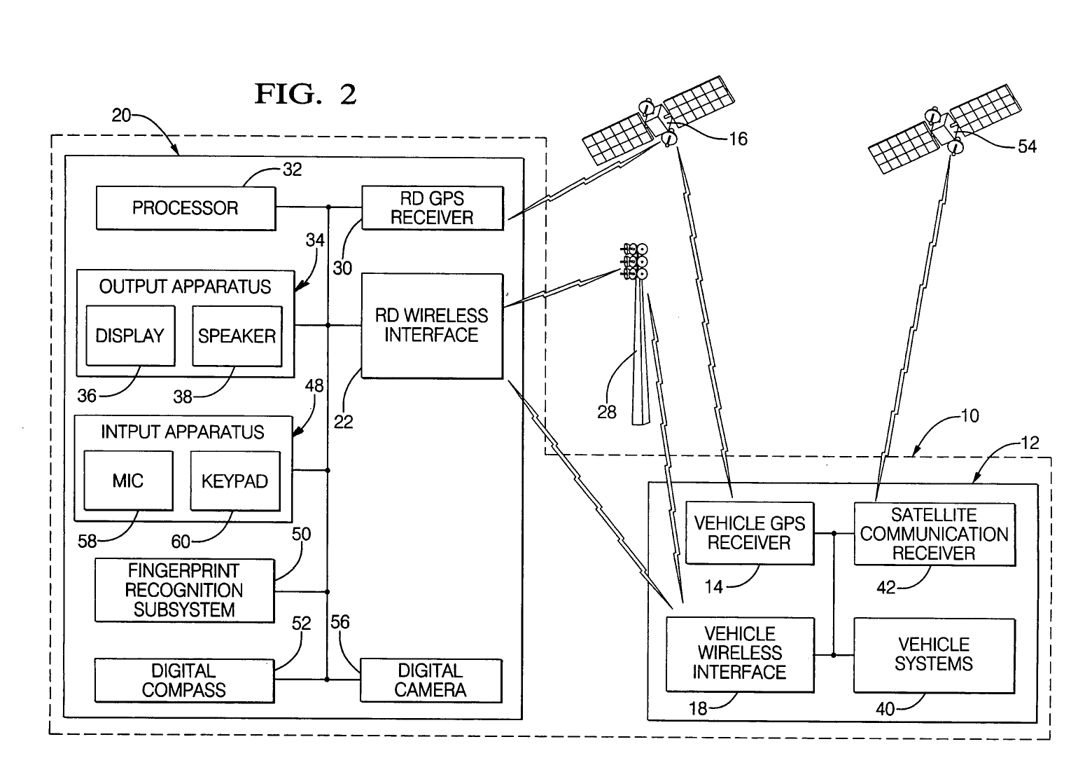

Referring now to FIG. 2, showing a preferred embodiment of the communications system 10, the vehicle 12 is equipped with a vehicle wireless interface 18. The vehicle wireless interface 18 is capable of communicating with the remote device 20 via a cellular telephone network 28. Examples of protocols used by the cellular telephone network 28 include, but are not limited to, Code Division Multiple Access (CDMA), Time Division Multiple Access (TDMA), and Global System for Mobile Communications (GSM).

The vehicle wireless interface 18 is also capable of communicating directly with the remote device 20. Preferably, this communication is performed utilizing the Bluetooth® protocol as established by the Bluetooth® Special Interest Group headquartered in Overland Park, Kans. and located on the internet at http://www.bluetooth.org. However, other protocols, systems, and the like may be used to establish communications directly between the vehicle wireless interface 18 and the remote device 20.

The vehicle 12 is equipped with a vehicle global positioning system (GPS) receiver 14. The vehicle GPS receiver 14 determines location coordinates of the vehicle 12 based on signals received from GPS satellites 16 orbiting the Earth. The vehicle 12 also includes a satellite communication receiver 42. The satellite communication receiver 42 is able to receive data from service satellites 54, such as those utilized by the OnStar® Corporation of Troy, Mich. Those skilled in the art recognize that the satellite communication receiver 42 can also receive data from satellites 54 from a variety of service providers. The vehicle GPS receiver 14 and the satellite communication receiver 42 are operatively connected to the vehicle wireless interface 18.

The vehicle wireless interface 18 is also operatively connected to at least one vehicle system 40. Examples of vehicle systems 40, include, but are not limited to the ignition/starter, door locks, trunk latch, engine controller, radio, instrument cluster, climate controls, and security.

The vehicle wireless interface 18 transmits information about the vehicle 12. This information includes the location coordinates of the vehicle 12. The vehicle wireless interface 18 also transmits data from the at least one vehicle system 40 or the satellite communication receiver 42. Additionally, the vehicle wireless interface 18 can receive data from the remote device 20, such as commands to start the vehicle's 12 engine, turn up the volume on the radio, open the door locks, engage the security system, etc.

Still referring to FIG. 2, the remote device 20 includes a remote device wireless interface 22. The remote device wireless interface 22 transmits and receives data to and from the vehicle 12 via the vehicle wireless interface 18. The remote device wireless interface 22 is capable of communicating with the cellular telephone network 28. As state above, examples of protocols used by the cellular telephone network 28 include, but are not limited to, Code Division Multiple Access (CDMA), Time Division Multiple Access (TDMA), and Global System for Mobile Communications (GSM).

The remote device wireless interface 22 is also capable of communicating directly with the vehicle wireless interface 18. Again, this communication is preferably performed utilizing the Bluetooth® protocol. However, other protocols, systems, and the like may be used to establish communications directly between the remote device wireless interface 22 and the vehicle wireless interface 18.

Data received by the remote device wireless interface 22 from the vehicle 12 includes, but is not limited to, status of the vehicle systems 40, information from the satellite communication receiver 42, and the location coordinates of the vehicle 12.

The remote device 20 also includes a remote device GPS receiver 30 and a digital compass 52. The remote device GPS receiver 30 determines location coordinates of the remote device 20 based on signals received from the GPS satellites 16. The digital compass 52 senses the direction that the remote device 20 is pointing towards based on the magnetic field of the Earth.

The remote device 20 further includes a processor 32. The processor 32 is operatively connected to the remote device wireless interface 22, the remote device GPS receiver 30, and the digital compass 52. The position of the vehicle 12, in relation to the position of the remote device 20, is calculated by the processor 32.

An output apparatus 34, operatively connected to the processor 32, is also included with the remote device 20. The output apparatus 34, among other functions, indicates direction, distance, and elevation difference to the vehicle 12 from the remote device 20. In the preferred embodiment, the output apparatus 34 includes a display 36 to graphically show direction, distance, and elevation difference to the vehicle 12 from the remote device 20. An arrow 44, shown on the display 36, indicates direction to the vehicle 12. The user 46, by holding the remote communicator in their hand and viewing the display 36, can follow the arrow 44 to easily find his or her vehicle 12. This is very useful, especially when looking for your vehicle at busy parking lots, such as shopping malls, entertainment arenas, airports, etc. The elevation difference measurement is especially beneficial when searching for the vehicle in a multi-layer parking structure. In the preferred embodiment, the output apparatus also includes a speaker 38. The remote device 20 can also audibly communicate direction, distance, and elevation difference to the vehicle 12 via the speaker 38.

The output apparatus 34 of the remote device 20 also indicates status data from one or more vehicle systems 40 of the vehicle 12. In the preferred embodiment, the status data can be presented on the display 36 or through the speaker 38. The status data includes, but is not limited to: engine running status, alarm system status, climate control settings, current speed of vehicle, frequency radio is tuned to, and so forth.

The remote device 20 also includes an input apparatus 48. The input apparatus 48 is operatively connected to the processor 32. In the preferred embodiment, the input apparatus 48 comprises a keypad 60 and a microphone 58. However, other embodiments may utilize pushbuttons, a control knob, a touchscreen panel, etc., as elements of the input apparatus 48. The input apparatus 48 allows the user 46 to input data or commands into the remote device 20 to control one or more systems 40 of the vehicle 12. These command and data are transmitted to the vehicle 12 via the remote device wireless interface 22 and the vehicle wireless interface 18. For instance, on a cold winter day, the user 46 could use the remote device 20 to warm-up the vehicle 12 by turning on the engine and setting the climate controls. Or, the user 46 could change radio stations or adjust volume of the radio while outside of the vehicle 20. The remote control operations possible with the subject invention are seemingly endless.

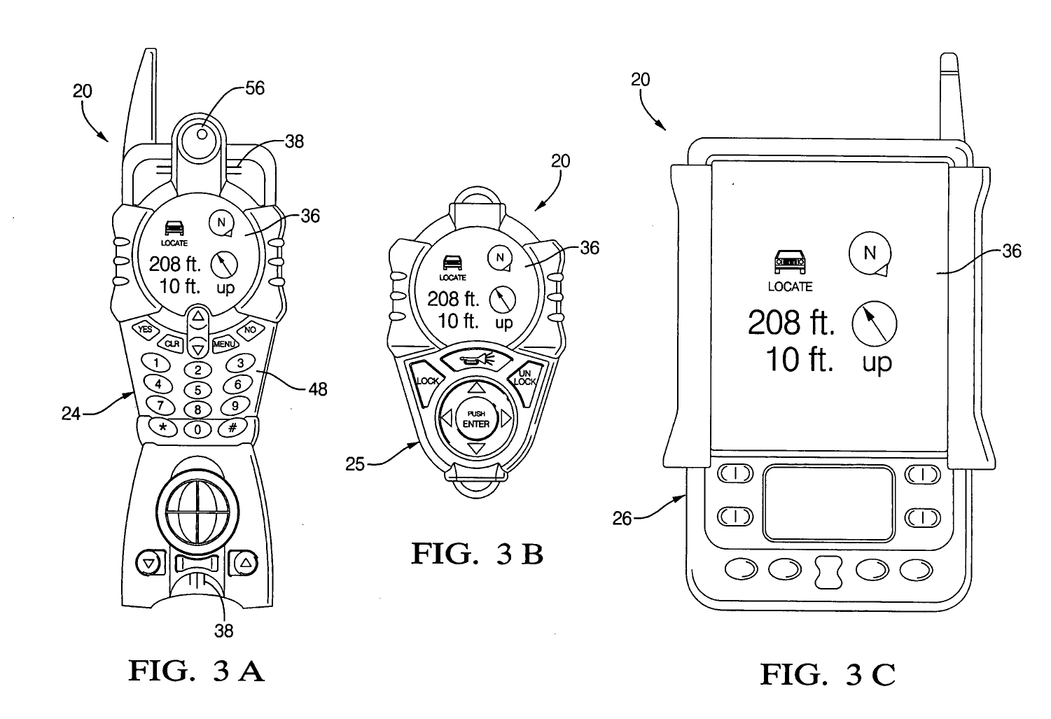

In the preferred embodiment, the remote device 20 further includes a fingerprint recognition subsystem 50. The fingerprint recognition subsystem 50 is operatively connected to the processor 32 and includes a fingerprint sensor 51. (The fingerprint sensor 51 is shown in FIG. 3a.) The user 46 places his or her finger on the fingerprint sensor 51. The user's 46 fingerprint is scanned into an image. The image is compared to other images stored in the subsystem 50 to verify the identity of the user 46. The remote device 20 can be configured to prevent all usage of the remote device 20 unless the user 46 is verified by subsystem 50. Alternatively, certain functions of the vehicle 12, such as engine starting or door unlocking, can be blocked if the user 46 is not verified.

An additional feature of the preferred embodiment of the remote device 20 is an integrated digital camera 56. The user 46 is able to capture images and send the images to the vehicle 12 or other users of the cellular telephone network 28.

In the preferred embodiment, the remote device 20 is realized as a cellular telephone 24, as shown in FIG. 3a. As outlined above, the output apparatus 34 of the cellular telephone 24 includes a display 36 and a speaker 38. The input apparatus 48 includes a microphone 58 and a keypad 60.

In a first alternative embodiment, as shown in FIG. 3b, the remote device is realized as a key fob 25, with pushbuttons to lock and unlock the doorlocks of the vehicle 12. In a second alternative embodiment, referring to FIG. 3c the remote device 20 is realized as a personal digital assistant (PDA) 26. PDAs are capable of storing and processing data, typically including names, addresses, phone numbers, meetings, appointments, etc. It is understood by those skilled in the art that additional embodiments are possible utilizing a wide variety of devices.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A remote device for communicating with a vehicle equipped with a vehicle global positioning system (OPS) receiver for determining location coordinates of the vehicle and a vehicle wireless interface for transmitting the location coordinates of the vehicle, said remote device comprising:
a remote device wireless interface for receiving the location coordinates of the vehicle;
a remote device GPS receiver for determining location coordinates of said remote device;
a processor operatively connected to said remote device wireless interface and said remote device GPS receiver for calculating the relative position of said remote device to the vehicle;
said remote device characterized by an output apparatus operatively connected to said processor for indicating direction, and graphically displaying distance and elevation difference values to the vehicle from said remote device.

2. (canceled)

3. A remote device as set forth in claim 1 further comprising a digital compass for determining the direction said remote device is pointed towards.

4. A remote device as set forth in claim 3 wherein said display (36) shows an arrow to indicate direction to the vehicle.

5. A remote device as set forth in claim 1 wherein said output apparatus is a speaker for audibly communicating direction, distance, and elevation difference to the vehicle from said remote device.

6. A remote device as set forth in claim 1 further comprising an input apparatus operatively connected to said processor for inputting data or commands into said remote device for controlling at least one system of the vehicle.

7. A remote device as set forth in claim 1 wherein said output apparatus indicates status data from one or more systems of the vehicle.

8. A remote device as set forth in claim 1 further comprising a fingerprint recognition subsystem operatively connected to said processor for verifying the identity of a user of said remote device.

9. A remote device as set forth in claim 1 further comprising a digital compass for indicating direction.

10. A remote device as set forth in claim 1 further comprising a digital camera for recording images.

11. A remote device as set forth in claim 1 wherein said remote device is a cellular telephone further comprising:
a microphone operatively connected to said processor for receiving audible signals;
a speaker operatively connected to said processor for conveying audible signals;
a keypad operatively connected to said processor for entering phone numbers and other data into said device;
wherein said remote device wireless interface communicates with a cellular telephone network.

12. A remote device as set forth in claim 1 wherein said remote device is a personal digital assistant (PDA) for storing and organizing data.

13. A remote device as set forth in claim 1 wherein said remote device is a key fob for controlling door locks of the vehicle.

14. A communications system comprising:
a vehicle including:.
a vehicle global positioning system (OPS) receiver for determining location coordinates of said vehicle; and
a vehicle wireless interface for transmitting said location coordinates of said vehicle; and
a remote device including:
a remote device wireless interface for receiving said location coordinates of said vehicle from said vehicle wireless interface;
a remote device GPS receiver for determining location coordinates of said remote device;
a processor operatively connected to said remote device wireless interface and said remote device GPS receiver for calculating a relative position of said remote device to said vehicle; and
an output apparatus operatively connected to said processor for indicating direction, and graphically displaying distance and elevation difference values to said vehicle from said remote device.

15. (canceled)

16. A communication system as set forth in claim 14, wherein said remote device further comprises a digital compass for determining the direction said remote device is pointed towards.

17. A communications system as set forth in claim 16 wherein said display shows an arrow to indicate direction to said vehicle.

18. A communications system as set forth in claim 14 wherein said output apparatus is a speaker for audibly communicating direction, distance, and elevation difference to said vehicle from said remote device.

19. A communications system as set forth in claim 14 wherein said vehicle wireless interface is operatively connected to at least one system of said vehicle for sending commands to said at least one system and receiving data from said at least one system.

20. A communications system as set forth in claim 19 wherein said remote device further includes an input apparatus operatively connected to said processor for inputting data or commands into said remote device for controlling said at least one system of said vehicle.

21. A communications system as set forth in claim 19 wherein said output apparatus indicates status data from one or more systems of said vehicle.

22. A communication system as set forth in claim 14 wherein said remote device further comprises a fingerprint recognition subsystem operatively connected to said processor for verifying the identity of a user of said remote device.

23. A communication system as set forth in claim 14 wherein said remote device further comprising a digital compass for indicating direction.

24. A communication system as set forth in claim 14 wherein said remote device further comprises a digital camera for recording images.

25. A communication system as set forth in claim 14 wherein said remote device is a cellular telephone further comprising;
a microphone operatively connected to said processor for receiving audible signals;
a speaker operatively connected to said processor for conveying audible signals;
a keypad operatively connected to said processor for entering phone numbers or other data into said remote device;
wherein said remote device wireless interface communicates with a cellular telephone network.

26. A communication system as set forth in claim 14 wherein said remote device is a personal digital assistant (PDA) for storing and organizing data.

27. A communication system as set forth in claim 14 wherein said remote device is a key fob for controlling door locks of the vehicle.
